(19) United States
(12) Patent Application Publication
(10) Pub. No.: US 2019/0218013 A1
(43) Pub. Date: Jul. 18, 2019

(54) Instant Scrambled Egg Product and Method

(71) Applicant: Irving Place Foods, Inc., New York, NY (US)

(72) Inventor: Senem Yaman, New York, NY (US)

(21) Appl. No.: 16/249,710

(22) Filed: Jan. 16, 2019

Related U.S. Application Data
(60) Provisional application No. 62/618,380, filed on Jan. 17, 2018.

(51) Int. Cl. B65D 81/34; A23L 5/30; A23L 15/00; A23L 5/10

(52) U.S. Cl. CPC B65D 81/3453; A23L 5/34; A23L 15/30; B65D 2581/341; A23L 5/15; A23V 2002/00; A23L 5/13

(57) ABSTRACT

Embodiments disclosed herein include provision of a convenient, single-serving microwaveable egg product including a microwaveable container with a seal, portion of egg crystals, fill-line to indicate the amount of water to add, and lid for portability of the prepared product. Also disclosed herein is a method of using the product including removing the seal, adding water, and mixing until fully dissolved. The container is placed in the periphery of a microwave oven platter and heated for an initial period. The contents are mixed and the container is moved to a central position of the microwave oven platter for a second period, further mixing is performed midway through this second period. Placing the container at the periphery of the platter allows the mixture to heat quickly, cuts cooking time and enhances convenience. Moving the container to the center slows the heating process, avoids overcooking, and enhances organoleptic properties of the eggs.

### FIELDS OF ART

The disclosed systems and methods generally relate to the fields of food products and preparation, and specifically to products and methods of microwaveable single serving egg food products.

### BACKGROUND

Many single serving microwaveable food products are known. Each presents different challenges. For some products, there is a consumer preference for browning and crispness, which has been challenging to achieve in the past with microwave heating. For others, such as popcorn, there is a concern that while some portion of the product will receive too much heating (e.g., already popped kernels) other portions may not receive enough (e.g., unpopped kernels).

Egg products have proven particularly difficult in the single serving convenience microwave preparation space. Use of fresh eggs dramatically limits shelf life, and reduces convenience significantly if the eggs are provided in-shell. Powdered egg products are known but are typically provided in larger bags, tins or jars, generally for institutional use, incorporation into baked goods and other recipes, and for emergency rations. Such large containers reduce convenience by requiring a user to spoon out the appropriate quantity of product before using, and open containers typically reduce shelf life for the remaining egg product.

Furthermore, microwave preparation of egg products often produces results that do not have satisfying texture or otherwise have undesirable mouthfeel. In particular, microwave cooking is known to give eggs a rubbery texture, typically attributed to uneven heating that results in some portions being overheated. Overheating is known to cause proteins in the egg to change in a manner that removes moisture from the overheated portion (thereby facilitating yet more overheating) and changing the texture of the product.

It would be desirable to have a product and method providing convenient, single-serving microwaveable eggs that have improved characteristics over known products and methods.

### SUMMARY

Embodiments disclosed herein include provision of a convenient, single-serving microwaveable egg product that includes a microwaveable container with a removable seal, in which a single serving portion of egg crystals is included. The container is marked with a fill line to indicate the amount of water to add for appropriately reconstituting the eggs from the crystals. A lid is also provided for portability of the prepared food product.

Also disclosed herein is a method of using the product that includes removing the seal, adding water to the fill line and mixing the water and the crystals until they are fully dissolved. Optionally, shaking or beating the mixture to introduce air and produce a fluffier product can be done at this point. The container is then placed in the periphery of a microwave oven platter and heated for an initial period, where the oven tends to be hotter. The contents are further mixed and the container is moved to a central position of the microwave oven platter, where the oven tends to be cooler, for a second period, with a further mixing step midway through this second period. Placing the container at the periphery of the platter initially allows for the cold liquid mixture to heat up quickly, cutting down overall cooking time and thus enhancing convenience. Moving the container to the center in the second period, combined with mixing the content midway to distribute heat and moisture, slows down the heating process, avoiding overcooking and the undesirable rubbery texture. Once cooking is complete, one more mixing is performed to break up the egg products before consumption.

### BRIEF DESCRIPTION OF DRAWINGS

FIG. 1 illustrates a single serving microwaveable egg food product.

FIG. 2 illustrates a method of moving a container of the egg food product from a peripheral position of a rotating microwave platter to a central position of the microwave platter during preparation.

The figures depict embodiments for purposes of illustration only. One skilled in the art will readily recognize from the following description that alternative embodiments of the structures and methods illustrated herein may be employed without departing from the principles described herein.

### DETAILED DESCRIPTION

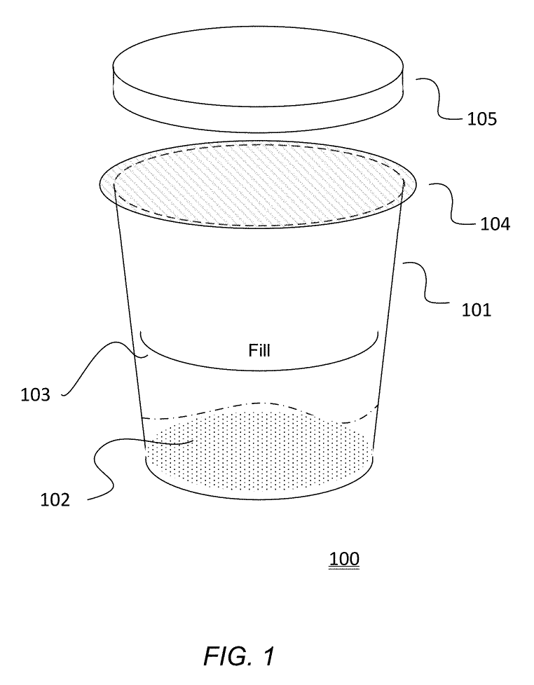

FIG. 1 illustrates various components of a single serving microwaveable food product 100, according to one embodiment. A microwaveable container 101 contains a single serving portion of egg crystals 102. In one embodiment, OVAEASY Whole Egg Crystals from Nutriom LLC of Lacey, Wash. are used for the egg ingredient and are found to combine suitable characteristics with respect to mixing, shelf life and taste/mouthfeel. In other embodiments, other dried egg products (e.g., dried egg powder) may be used.

A removable seal 104 keeps the egg crystals isolated from humidity, air exchange, insects and the like in order to maintain shelf life of the product. In practice, it is found that packaging the crystals 102 in the container 101 under normal food processing atmospheric conditions is suitable to yield a commercially reasonable shelf life of approximately 12 to 18 months. Should longer shelf life be desired, packing under moderate vacuum, low moisture, or inert gas (e.g., nitrogen) may be employed, as well as other known shelf life enhancing techniques.

In one embodiment, container 101 is implemented using a conventional coated paper hot cup, e.g., Visstun model H9U2, on which instructions and a fill line 103 is printed. The use of fill line 103 adds to convenience by removing the need for any measuring cup, etc. for adding water. In some embodiments, rather than printing fill line 103 it is embossed on container 101 so that it is more readily visible from the inside of the cup.

In some embodiments, seal 104 is a simple coated paper seal that is removable but not resealable on container 101. In most cases, it is assumed that a user will have a fork or other such utensil available for consuming the product, and such utensil can also be used to mix the egg and water.

In some embodiments, a lid 105 is also provided. In some embodiments, lid 105 merely provides for some retention of heat and protection of the cooked food for portability, etc. In these embodiments, a standard plastic lid (e.g., Visstun VKU2NF) is used. In other embodiments, however, different lids may be more appropriate. For example, a single reusable lid may be provided with a multipack of filled containers 101, such that there is less waste involved in use of product 100. In some embodiments for such situations, lid 104 is a silicone or other washable, microwave-safe lid that fits snugly over the top of container 101 to allow mixing by shaking, etc. as described above in connection with seal 104, thus obviating any need for seal 104 to be used during preparation.

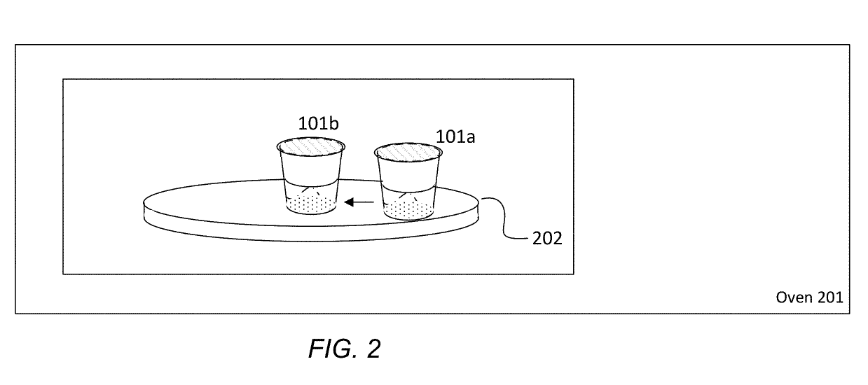

Referring now also to FIG. 2, in one embodiment a method of preparing the food product takes into account that commonly, microwave ovens (e.g., oven 201) do not evenly heat food products placed within them. This is due to a number of reasons. First, microwaves, which are electromagnetic radio waves that oscillate at a frequency of several billion cycles per second, are absorbed differently by different materials, much the same way as infrared heat is absorbed more by dark, porous (e.g., cast iron) than light, reflective materials (e.g., aluminum foil). Second, a microwave oven is much like a radio transmitter and antenna, and the strength of the signal it produces is not uniform within the cavity of the oven, much like radio signals are stronger in some locations than in others due to topography, etc. It is common for microwave ovens to have greater intensity of signal (referred to by some as anti-nodes) toward the periphery of the oven than in the center (where the signal has lower-energy, referred to by some as nodes).

Since it is known that overheating of eggs during cooking causes a rubbery texture and undesirable organoleptic properties to result from structural changes in egg proteins, it is desirable to use less intense heating toward the end of the cooking process.

Both convenience and quality of the cooked eggs are found to be enhanced by the following method. After the user adds water up to the fill line, the user is directed to mix the egg crystals and water. As mentioned above, this can be achieved through use of a utensil such as a fork or spoon. Whisking or beating, whether with a fork a whisk, or some other utensil that helps to introduce significant air to the mixture, is optional and leads to a fluffier product. Alternatively, mixing by shaking as discussed above achieves similar results. Referring still to FIG. 2, container 101a with the unheated mixture is placed on the periphery of platter 202 of oven 201. In one embodiment, the eggs are heated using this placement for an initial 30-second period.

After this initial heating, the user is instructed to again mix the partially heated egg/water mixture in preparation for a second stage of cooking. For this second stage, the container 101b is moved to a more central location on platter 202, where heating is likely to be not as intense. In one embodiment, this final stage of heating is for a period of 20 seconds. The user is instructed to once again mix the contents mid-way through this stage to redistribute heat and moisture and to further reduce the likelihood of any particular portion being overheated. After final heating, the user is instructed to mix the cooked eggs to break up the cooked eggs, for instance by fluffing with the fork or other eating utensil, to once again reduce the likelihood of any overheated portions, and also to make the food product more like conventionally cooked scrambled eggs, which preferentially do not adhere together as a single mass. Mixing the cooked eggs also redistributes any remaining liquid so that the overall texture of the cooked eggs is creamy.

In this manner, a convenient single-serve microwaveable egg food product provides a nutritious and enjoyable product that can be quickly prepared, without utensils if desired, in its own to-go packaging.

What is claimed is:

1. A method comprising:
retrieving a microwaveable cup containing a first amount of a dried egg product, the microwaveable cup including a seal, a lid, and a fill line;
removing the seal and the lid from the microwaveable cup;
adding a second amount of a liquid to the microwaveable cup, such that the microwaveable cup is filled to the fill line;
producing a homogenous mixture by dissolving the dried egg product into the liquid;
cooking the homogenous mixture to produce a fully cooked egg product by:
placing the microwaveable cup along a peripheral portion of a platter in a microwave oven;
heating the homogenous mixture in the microwave oven for a first amount of time to produce a partially cooked egg product;
placing the microwaveable cup in a central portion of the platter in the microwave oven; and
heating the partially cooked egg product in the microwave oven for a second amount of time to produce the fully cooked egg product.

2. The method of claim 1, wherein heating the partially cooked egg product further comprises:
removing the microwaveable cup from the microwave oven part-way through the second amount of time;
further mixing the partially cooked egg product; and
placing the microwaveable cup in the central portion of the platter in the microwave oven; and
heating the microwaveable cup for a remainder of the second amount of time.

3. The method of claim 1, wherein the first amount of time is thirty seconds.

4. The method of claim 1, wherein the second amount of time is twenty seconds.

5. The method of claim 1, wherein producing a homogenous mixture further comprises:
mixing the dried egg product and the liquid until the dried egg product is dissolved into the liquid.

6. The method of claim 1, wherein producing a homogenous mixture further comprises:
whisking the dried egg product and the liquid using a utensil.

7. The method of claim 1, wherein cooking the homogenous mixture further comprises:
further mixing the partially cooked egg product to redistribute heat and the liquid and to divide the partially cooked egg product into smaller portions.

8. The method of claim 1, further comprising:
further mixing the cooked egg product to divide the cooked egg product into smaller portions.

9. A method comprising:
placing a microwaveable cup containing a first amount of a dried egg product and a second amount of a liquid along a peripheral portion of a platter in a microwave oven, the microwaveable cup including a seal;
heating the microwaveable cup in the microwave oven for a first amount of time to produce a partially cooked egg product;
removing the microwaveable cup from the microwave oven after the first amount of time;
dividing the partially cooked egg product into smaller portions;
placing the microwaveable cup in a central portion of the platter in the microwave oven; and
heating the microwaveable cup for a second amount of time to produce a fully cooked egg product.

10. The method of claim 9, wherein the first amount of time is thirty seconds.

11. The method of claim 9, wherein the second amount of time is twenty seconds.

12. The method of claim 9, further comprising:
removing the microwaveable cup from the microwave oven part-way through the second amount of time;
further mixing the partially cooked egg product; and
placing the microwaveable cup in the central portion of the platter in the microwave oven; and
heating the microwaveable cup in the microwave oven for a remainder of the second amount of time.

13. A method comprising:
retrieving a microwaveable cup containing a first amount of a dried food product, the microwaveable cup including a seal and a fill line;
removing the seal from the microwaveable cup;
adding a second amount of a liquid to the microwaveable cup, such that the microwaveable cup is filled to the fill line;
producing a homogenous mixture by dissolving the dried food product into the liquid;
cooking the homogenous mixture to produce a fully cooked food product by:
placing the microwaveable cup along a peripheral portion of a platter in a microwave oven;
heating the homogenous mixture in the microwave oven for a first amount of time to produce a partially cooked food product;
placing the microwaveable cup in a central portion of the platter in the microwave oven; and
heating the partially cooked food product in the microwave oven for a second amount of time to produce the fully cooked food product.

14. The method of claim 13, wherein heating the partially cooked food product further comprises:
removing the microwaveable cup from the microwave oven part-way through the second amount of time;
further mixing the partially cooked food product;
placing the microwaveable cup in the central portion of the platter in the microwave oven; and
heating the microwaveable cup in the microwave oven for a remainder of the second amount of time.

15. The method of claim 13, wherein the first amount of time is thirty seconds.

16. The method of claim 13, wherein the second amount of time is twenty seconds.

17. The method of claim 1, wherein cooking the homogenous mixture further comprises:
further mixing the partially cooked food product to redistribute heat and the liquid and to divide the partially cooked food product into smaller portions.

18. The method of claim 13, wherein producing a homogenous mixture further comprises:
further mixing the dried food product and the liquid until the dried food product is dissolved into the liquid.

19. The method of claim 13, wherein producing a homogenous mixture further comprises:
whisking the dried food product and liquid using a utensil.

20. The method of claim 13, further comprising:
further mixing the cooked food product to divide the cooked food product into smaller portions.
